(19) United States
(12) Patent Application Publication
(10) Pub. No.: US 2017/0330277 A1
(43) Pub. Date: Nov. 16, 2017

(54) SYSTEMS AND METHODS FOR VOICE-CONTROLLED ACCOUNT SERVICING

(71) Applicant: CAPITAL ONE SERVICES, LLC, McLean, VA (US)

(72) Inventors: Justin Wishne, Chicago, IL (US); Matthew Dabney, Chicago, IL (US); Karen Nickerson, Chicago, IL (US); Scott Totman, Vienna, VA (US); Panayiotis Varvarezis, Glenolden, PA (US); Keshav Gupta, Ashburn, VA (US)

(21) Appl. No.: 15/667,071

(22) Filed: Aug. 2, 2017

Related U.S. Application Data
(63) Continuation of application No. 15/375,038, filed on Dec. 9, 2016.
(60) Provisional application No. 62/266,266, filed on Dec. 11, 2015.

(51) Int. Cl. G06Q 40/02; G06Q 20/34; G10L 15/30; G10L 15/22; G06F 21/31; G06Q 20/10; G06F 21/62; G06F 21/32; H04L 29/06; G10L 15/18

(52) U.S. Cl. CPC G06Q 40/02; H04L 63/08; G06Q 20/34; G10L 15/30; G10L 15/22; G10L 15/1822; G06F 21/31; G06Q 20/10; G06F 21/6218; G06F 21/32; G06F 21/313; G10L 2015/223

(57) ABSTRACT

Aspects of the present disclosure relate to a method that includes receiving, at a processor and from a computing device, a data file comprising data representative of a voice command received at the computing device from a user and, responsive to determining that the voice command is directed to a banking-related inquiry, transmitting a request for user authentication information. Further, the method can include receiving and verifying the user authentication information and, responsive to determining that the voice command comprises a request for information relating to a banking account of the user, querying the banking account for the requested information. Additionally, the method can include outputting data indicative of the requested information and, responsive to determining that the voice command comprises a request to initiate payment from the banking account of the user to a third party, initiating electronic payment to the third party.

### CROSS-REFERENCE TO RELATED APPLICATION

This application is a continuation of U.S. patent application Ser. No. 15/375,038, filed 9 Dec. 2016, entitled “Systems and Methods for Voice-Controlled Account Servicing”, which claims the benefit of U.S. Provisional Application No. 62/266,266, filed 11 Dec. 2015, the entire contents and substance of which are hereby incorporated by reference.

### BACKGROUND

Computing devices, such as mobile phones, tablet computers, laptop computers, or wearable devices, allow users to access sensitive content such as, for example, account information. Account information may include banking information, rewards/loyalty information, historic information (e.g., purchases, browsing information, offers, and information generated therefrom), utility account information, medical information, and other nonpublic information accessible by the user via, for instance, a password or personal identification number (“PIN”). Generally, users access account information via an application, installed on a computing device, that is associated with the account information. Alternatively, users can often access account information via a website associated with the account information via a web browser executing on the computing device. Often, users experience difficulty or frustration accessing account information because associated applications or websites typically require users to manually enter user names, passwords, and other account-related information, which can be cumbersome to input, particularly on devices that do not utilize a traditional keyboard. Further, once a user is able to access his account, the user often experiences further difficulty in completing the tasks he set out to accomplish by accessing the account.

Aspects of existing speech recognition technology and, in particular, internet-enabled voice command devices, allow users to utilize voice commands to, for example, control smart devices or ask questions that can be answered based on an internet query. Such technology, however, may not enable users to access sensitive content such as account information.

Accordingly, a need exists for systems and methods that allow users an improved experience when accessing sensitive content such as account information and completing tasks associated with the account. In particular, a need exists for such systems and methods that utilize voice-recognition technology and allow users to interact with the account using natural language.

### SUMMARY

Disclosed implementations provide systems and methods for providing users access to sensitive content such as account information, such systems and methods utilizing voice-recognition technology that allows users to interact with the systems and methods using natural language.

Consistent with the disclosed implementations, the system may include one or more processors and a memory coupled to the one or more processors and storing instructions that, when executed by the one or more processors, cause the system to receive, from a computing device, a data file that includes data representative of a voice command received at the computing device from a user. The one or more processors may further execute instructions that cause the system to transmit a request for user authentication information responsive to determining that the voice command is directed to a banking-related inquiry, and verify the user authentication information once it is received. Additionally, the one or more processors may execute instructions that cause the system to query a banking account for requested information in response to determining that the voice command includes a request relating to the banking account. Finally, the one or more processors may execute instructions that cause the system to output data indicative of the requested information.

Consistent with the disclosed implementations, methods for providing users access to sensitive content such as account information using voice-recognition technology that allows users to interact with the systems and methods using natural language.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

Reference will now be made to the accompanying FIGS., which are not necessarily drawn to scale, and which are incorporated into and constitute a portion of this disclosure, illustrate various implementations and aspects of the disclosed technology and, together with the description, serve to explain the principles of the disclosed technology. In the FIGS.:

FIG. 1 depicts computing system architecture 100, according to an example implementation of the disclosed technology;

FIG. 2 is an overview of an environment 200 illustrating components that may be used in an example implementation of the disclosed technology;

FIG. 3 is a sequence diagram of an exemplary process 300, according to an example implementation;

FIG. 4 is a sequence diagram of an exemplary process 400, according to an example implementation; and

FIG. 5 is a flow diagram of a method 500, according to an example implementation.

### DETAILED DESCRIPTION

Some implementations of the disclosed technology will be described more fully with reference to the accompanying drawings. This disclosed technology may, however, be embodied in many different forms and should not be construed as limited to the implementations set forth herein.

Example implementations of the disclosed technology can provide systems and methods for voice-controlled account servicing. For example, some implementations utilize speech recognition technology and thus allow a user to access and interact with sensitive information such as account information. According to example implementations, a computing device (e.g., a user device) receives a user's voice command, which can be a natural-language voice command or request. The user device can create a capture of the voice command, such as an audio file, which the user device can process and convert to a data file, which may be a text string representing the user's voice command. Based on the data file, the user device can set about determining the intent of the user's voice command. Upon determining the voice command was intended to access or interact with an account associated with the user, the user device can transmit the data file to a remote server associated with the user's account. The server can further process the data file to determine the exact nature of the user's command. For example, if the voice command is directed to a user's financial account (e.g., bank account, credit card account, money market account, or other type of financial account), the command could relate to the account's balance, recent transactions, account rewards balance or redemption, budgeting questions, or bill payment questions. After determining the nature of the nature of the request, the server can request additional account authentication information or access the user's account for the requested information. Depending on the nature of the request, the server can output a response to the user device, which the user device can provide to the user as, for example, a verbal response or on a display associated with the user device. Alternatively, in some implementations, if the user request relates to a payment, the server can initiate a transaction with a designated payee on behalf of the user/payor.

Example implementations may include a method that comprises receiving, at a processor and from a computing device, a data file that comprises data representative of a voice command, which can be a natural-language voice command, received at the computing device from a user. The data file can include a text string that represents the text of the voice command. After determining that the voice command is directed to a banking-related inquiry (e.g., a request for an account balance or for an itemized list of purchases made during a particular time period), the method can include transmitting, to the computing device, a request for user authentication information. Additionally, the method can include receipt and authentication of the user authentication information in addition to querying a banking account for the requested information in response to determining that the voice command includes a request for information relating to the banking account. Finally, the method can include outputting data indicative of the requested information.

The method, in some example implementations, may further include initiating an electronic payment to a third-party account from the banking account or, conversely, initiating payment from a third-party account to the banking account. Further, in example implementations, the method can include initiating payment from a first bank account to a second bank account, both held by the user, and both provided by the same financial institution.

Example implementations of the disclosed technology will now be described with reference to the accompanying figures.

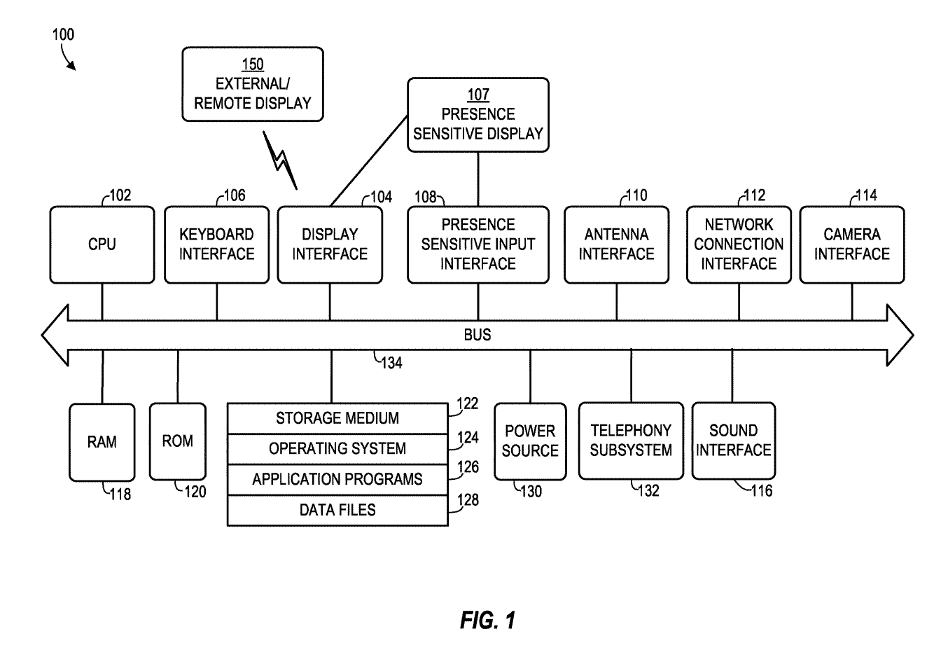

As desired, implementations of the disclosed technology include a computing device with more or fewer of the components illustrated in FIG. 1. It will be understood that the computing device architecture 100 is provided for example purposes only and does not limit the scope of the various implementations of the present disclosed systems, methods, and computer-readable mediums.

The computing device architecture 100 of FIG. 1 includes a central processing unit (CPU) 102, where computer instructions are processed; a display interface 104 that supports a graphical user interface and provides functions for rendering video, graphics, images, and texts on the display. In certain example implementations of the disclosed technology, the display interface 104 connects directly to a local display, such as a touch-screen display associated with a mobile computing device. In another example implementation, the display interface 104 is configured for providing data, images, and other information for an external/remote display 150 that is not necessarily physically connected to the mobile computing device. For example, a desktop monitor may be utilized for mirroring graphics and other information that is presented on a mobile computing device. In certain example implementations, the display interface 104 wirelessly communicates, for example, via a Wi-Fi channel, Bluetooth connection, or other available network connection interface 112 to the external/remote display.

In an example implementation, the network connection interface 112 is configured as a wired or wireless communication interface and provides functions for rendering video, graphics, images, text, other information, or any combination thereof on the display. In one example, a communication interface includes a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

The computing device architecture 100 may include a keyboard interface 106 that provides a communication interface to a physical or virtual keyboard. In one example implementation, the computing device architecture 100 includes a presence-sensitive display interface 108 for connecting to a presence-sensitive display 107. According to certain example implementations of the disclosed technology, the presence-sensitive input interface 108 provides a communication interface to various devices such as a pointing device, a capacitive touch screen, a resistive touch screen, a touchpad, a depth camera, etc. which may or may not be integrated with a display.

The computing device architecture 100 may be configured to use one or more input components via one or more of input/output interfaces (for example, the keyboard interface 106, the display interface 104, the presence sensitive input interface 108, network connection interface 112, camera interface 114, sound interface 116, etc.) to allow the computing device architecture 100 to present information to a user and capture information from a device's environment including instructions from the device's user. The input components may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, an input component may be integrated with the computing device architecture 100 or may be a separate device. As additional examples, input components may include an accelerometer (e.g., for movement detection), a magnetometer, a digital camera, a microphone (e.g., for sound detection), an infrared sensor, and an optical sensor.

Example implementations of the computing device architecture 100 include an antenna interface 110 that provides a communication interface to an antenna; a network connection interface 112 may support a wireless communication interface to a network. As mentioned above, the display interface 104 may be in communication with the network connection interface 112, for example, to provide information for display on a remote display that is not directly connected or attached to the system. In certain implementations, a camera interface 114 is provided that acts as a communication interface and provides functions for capturing digital images from a camera. In certain implementations, a sound interface 116 is provided as a communication interface for converting sound into electrical signals using a microphone and for converting electrical signals into sound using a speaker. According to example implementations, a random access memory (RAM) 118 is provided, where computer instructions and data may be stored in a volatile memory device for processing by the CPU 102.

According to example implementations, the computing device architecture 100 includes a read-only memory (ROM) 120 where invariant low-level system code or data for basic system functions such as basic input and output (I/O), startup, or reception of keystrokes from a keyboard are stored in a non-volatile memory device. According to example implementations, the computing device architecture 100 includes a storage medium 122 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), for storing files including an operating system 124, application programs 126 (including, for example, a web browser application, a widget or gadget engine, and or other applications, as necessary), and data files 128, which can include audio files representative of received voice commands. According to example implementations, the computing device architecture 100 includes a power source 130 that provides an appropriate alternating current (AC) or direct current (DC) to power components.

According to an example implementation, the computing device architecture 100 includes a telephony subsystem 132 that allows the device 100 to transmit and receive audio and data information over a telephone network. Although shown as a separate subsystem, the telephony subsystem 132 may be implemented as part of the network connection interface 112. The constituent components and the CPU 102 communicate with each other over a bus 134.

According to an example implementation, the CPU 102 has appropriate structure to be a computer processor. In one arrangement, the CPU 102 includes more than one processing unit. The RAM 118 interfaces with the computer bus 134 to provide quick RAM storage to the CPU 102 during the execution of software programs such as the operating system, application programs, and device drivers. More specifically, the CPU 102 loads computer-executable process steps from the storage medium 122 or other media into a field of the RAM 118 to execute software programs. Data may be stored in the RAM 118, where the computer CPU 102 can access data during execution. In one example configuration, and as will be understood by one of skill in the art, the device architecture 100 includes sufficient RAM and flash memory for carrying out processes relating to the disclosed technology.

The storage medium 122 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system, may be tangibly embodied in storage medium 122, which may include a non-transitory, machine-readable storage medium.

According to example implementations, the term “computing device,” as used herein, may be a CPU, or conceptualized as a CPU (for example, the CPU 102 of FIG. 1). In such example implementations, the computing device (CPU) may be coupled, connected, and/or in communication with one or more peripheral devices, such as display. In other example implementations, the term “computing device,” as used herein, may refer to a mobile computing device such as a smartphone, tablet computer, wearable device, voice command device, smart watch, or other mobile computing device. In such implementations, the computing device may output content to its local display and/or speaker(s). In another example implementation, the computing device may output content to an external display device (e.g., over Wi-Fi) such as a TV or an external computing system.

In example implementations of the disclosed technology, a computing device includes any number of hardware and/or software applications that are executed to facilitate any of the operations. In example implementations, one or more I/O interfaces facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections. For example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network, any wired network, any wireless network, etc., for communication with external devices and/or systems.

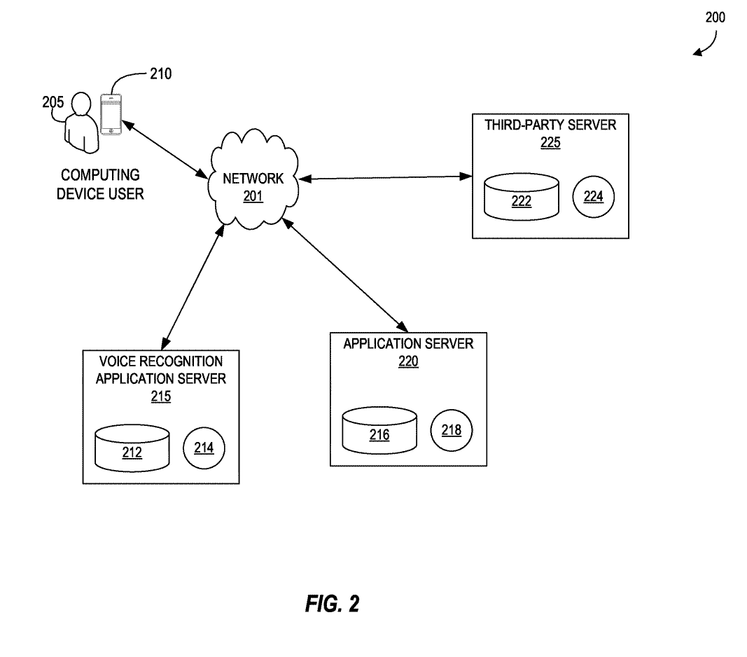

FIG. 2 is an overview of an implementation of components that may be included in and/or utilize a voice-controlled account servicing system in an exemplary environment 200. In some implementations, computing device user 205 may provide voice commands to computing device 210 (e.g., a mobile phone, laptop computer, tablet computer, wearable device, voice command device, or other computing device). Voice commands may take various formats including, for example: predetermined or predefined commands or inquiries; natural-language commands, questions, or requests; or other suitable voice commands. In some implementations, computing device 210 may be operatively connected (via, for example, network connection interface 112) to one or more remote servers, including voice recognition application server 215, application server 220, and third-party server 225 through a network 201, such as the internet. Further, in some implementations, the operative connections between, for example, computing device 210, voice recognition application server 215, application server 220, and third-party server 225 can be trusted, secure connections.

In some implementations, after receiving a voice command from computing device user 205 (e.g., via sound interface 116), computing device 210 can create a digital audio data file that represents the received voice command using, for example, an application program 126. Accordingly, in some implementations, the computing device 210 can create a waveform audio (“.WAV”) file, a free lossless audio codec (“FLAC”) file, or other suitable digital audio data file. According to some implementations, voice recognition application server 215 can be configured to receive audio files from computing device 210, process the received audio file, and convert the audio file into a separate data file such as, for example, a text file. In some implementations, application server 220 can be configured to receive the data file (e.g., from computing device 210 or voice recognition application server 215), and process the data file to determine the substance or nature of the voice command. Further, in some implementations, and depending on the nature of the voice command, application server 220 can be configured to output appropriate responses to computing device 210, initiate an account management action, or initiate a transaction or other communication with third-party server 225.

Though not shown, it will be understood by one of skill in the art that many remote servers can be operatively connected through a network 201. Generally, such operative connections involve a secure connection or communications protocol (i.e., a trusted connection), and communications over a network typically involve the use of one or more services such as a Web-deployed service with client/server architecture, a corporate Local Area Network (“LAN”) or Wide Area Network (“WAN”), or through a cloud-based system. According to some implementations, servers (e.g., voice recognition application server 215, application server 220, and third-party server 225) can comprise at least one database (e.g., 212, 216, and 222, respectively) and one or more processors (e.g., 214, 218, and 224, respectively) for carrying out various computer-implemented processes, including computer-implemented processes associated with a voice-controlled account servicing system. Further, though shown independently, according to some implementations, voice recognition application server 215 and application server 220 can be co-located. Likewise, as will be understood, an environment 200 for utilizing a voice-controlled account servicing system can comprise more or less components than shown in FIG. 2, and the components may include more or less of the components illustrated in FIG. 1.

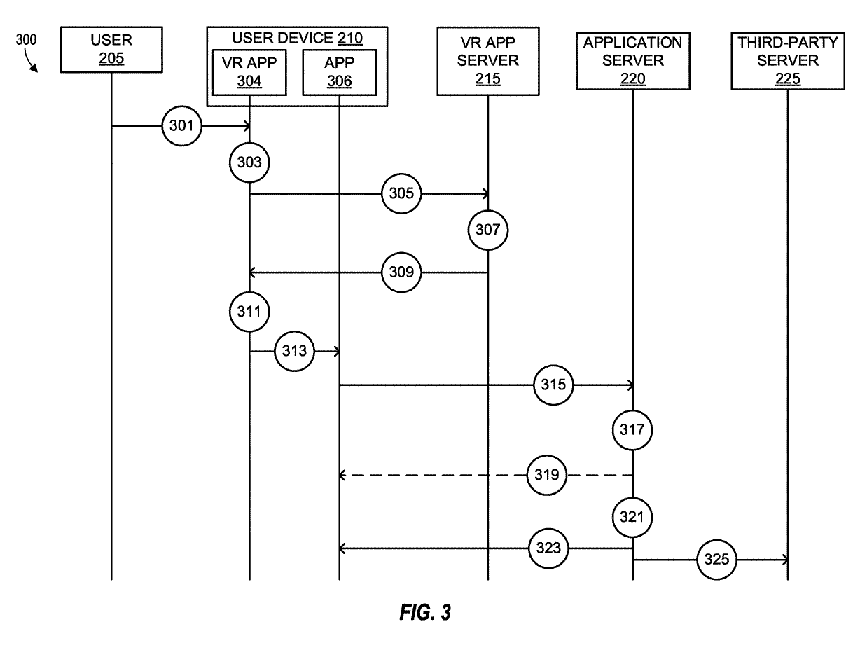

FIG. 3 is a sequence diagram illustrating an exemplary process 300, according to an example implementation. In certain implementations, as shown in FIG. 3, user device 210 may include various applications such as voice recognition application (VR APP) 304 and application 306. In some embodiments, computing device 210, VR APP 304, and or application 306 may be configured to receive voice commands (e.g., via sound interface 116), and create a digital audio file representing received voice commands. For example, in some implementations, computing device 210, VR APP 304, and/or application 306 may be configured to receive an indication of user input that prompts receipt, by computing device 210, VR APP 304, and/or application 306 of a voice command. In some implementations, user input may be a gesture (e.g., a touch gesture) by one or more input objects (e.g., one or more fingers or a stylus) placed at a presence-sensitive input device associated with the computing device (e.g., presence-sensitive display 107). The gesture may include holding of an input object at a particular location of the presence-sensitive input device for a predetermined period of time (to perform, e.g., a press-and-hold gesture). User input may also be the speaking of a predefined word, sound, or phrase that indicates a user's intent to provide a voice command. In response to receipt of an indication of user input to prompt receipt of an audio command, device 210, VR APP 304, and/or application 306 may activate an audio input device (such as a microphone included in or operatively coupled to computing device 210 via sound interface 116) to receive the audio command.

Accordingly, as shown in FIG. 3, in some implementations, VR APP 304 can receive 301 one or more voice commands from computing device user 205 and create 303 a digital audio file representative of the voice command. In some implementations, VR APP 304 can transmit 305 the digital audio file to voice recognition application server 215, which may be related to VR APP 304. Voice recognition application server 215 can be configured to process 307 the received digital audio file to create a separate data file of a different format (e.g., a text file or text string) representing the received voice command and transmit 309 the data file back to VR APP 304.

In some implementations, after receiving the data file back from voice recognition application server 215, VR APP 304 may process 311 the data file to determine the nature of the voice command and/or determine an appropriate application for further processing the command (e.g., application 306). For example, in some implementations, VR APP 304 may parse a text file and identify certain key words to determine the nature of the voice command and/or an appropriate application to further process the command. So, in the foregoing example, computing device user 205 may provide a voice command that relates to a financial account associated with computing device user 205. Accordingly, in some implementations, processing 311 may include determining the nature of the voice command (e.g., after determining the voice command is related to computing device user's 205 financial account). Further, as shown in FIG. 3, VR APP 304 may transmit 313 at least a portion of the data file to a proper application for further processing the command (e.g., application 306, which for the purpose of the foregoing example, is associated with computing device user's 205 financial account) for further processing. As will be understood and appreciated, VR APP 304 and application 306 can share data (e.g., digital audio file or other data file) using one or more application program interfaces (APIs).

As shown in FIG. 3, in some implementations, after receiving at least a portion of the data file, application 306 may transmit the at least a portion of the data file to an associated application server 220 which, according to the foregoing example, can be a server associated with computing device user's 205 banking account (e.g., a financial institution account). Accordingly, in some implementations, application server 220 can further process 317 the at least a portion of the data file to determine specifics related to the voice command. For example, as previously discussed, computing device user 205 may provide a voice command (or request or inquiry) relating to computing device user's 205 banking account. For example, a voice command may relate to current account balance or recent transactions (e.g., “What is my balance?”; “What was my most-recent purchase?”; “How much did I spend last night?”). Further, a voice command may relate to budgeting information (e.g., “How much have I spent at restaurants this month?”; “How much do I have left to spend on groceries?”; “How am I doing this week?”). Similarly, voice commands may relate to account rewards information (e.g., “How many points do I have?”; “How many rewards points did I earn last month?”; “What can I get with my rewards?”; “I'd like to redeem my points for ‘X’”). Additionally, a voice command may relate to a transaction with an associated account (e.g., “Have I paid my bill?”; “When is my bill due?”; “I'd like to pay my bill now”). Also, as will be understood, voice commands may be presented in the form of a predetermined, recognized command (e.g., “Balance?”) or as a natural-language command (e.g., “What is my current balance?”). Accordingly, application server 220 can parse the at least a portion of the date file to determine the specifics of the voice command received from computing device user 205.

As noted previously, in some implementations, application server 220 may be associated with various financial accounts including, for example, a banking account associated with computing device user 205. Accordingly, in some implementations, database 216 can store customer information (e.g., customer account information, which can include various account details such as name and contact information, account balance information, transaction information, other relevant account details, and any other non-public personal information or personally identifiable financial information provided by a customer to a financial institution, or resulting from a transaction with the customer or otherwise obtained by the financial institution). Further, in some implementations, database 216 can store various voice commands that are related to a user's banking account, or associated with the type of banking account maintained by the user at a financial institution, and that are recognizable by application server 220. Additionally, processor 218 may be configured for generating banking accounts, managing and servicing banking accounts, and processing information relating to banking accounts. Further, processor 218 may be configured to execute instructions relating to voice recognition technology that can process received data files relating to voice commands. Moreover, processor 218 may be configured to execute instructions for generating responses to voice commands and inquiries, or to follow a series of actions in response to a received voice command or inquiry.

In some implementations, application server 220 may determine that based on the nature of the voice command (e.g., that the voice command relates to sensitive financial information), additional security information is necessary. Accordingly, application server 220 may optionally transmit 319 a request to application 306 to obtain additional security information from computing device user 205, which computing device user 205 can provide verbally or manually. For example, computing device user 205 could be prompted to verbally provide an answer to a security question or provide a PIN number, Social Security Number, or various other account-verifying information via, for example, sound interface 116. Likewise, computing device user 205 could be prompted to manually provide account verification information (e.g., biometric information such as a fingerprint scan, one or more pattern scans or swipe gestures, or other account verification information) at, for example, presence-sensitive display 107. Further, in some implementations, a request for additional security information may comprise a multi-factor authentication. Thus, for example, application server 220 may generate a passcode and transmit the passcode to computing device 210 such that computing device user 205 can provide the passcode as a voice command that can be received and verified by, for example, VR APP 304 or application 306. Additionally, in some implementations, application 306 may utilize or incorporate voice recognition technology (e.g., voice biometrics) to further verify the identity of computing device user 205 based on, for example, received voice commands.

In some implementations, however, computing device user 205 can pre-register computing device 210 with application 306 and/or application server 220 such that it is not necessary to obtain additional security information. Put differently, computing device user 205 can pre-authorize his financial account for such voice commands. Thus, for example, an account holder can access a website provided by the financial institution associated with the financial account and preauthorize computing device 210 for utilizing voice commands in conjunction with the financial account. In some implementations, an identifier associated with a pre-registered computing device 210, such as smartphone device ID, serial number of the like, may be delivered with a data file or as part of the data file information, such as in data file header information or metadata. Further, in some implementations, the initial voice command can include account-verifying information (or user-verifying information) that gets converted as part of the digital audio and data file and propagated to application server 220.

Further, in some embodiments, application server 220 can determine whether additional security information is required based on the nature of the received voice command and the sensitivity of the requested information. Thus, for example, if the voice command relates to a request for account balance information, no additional security information may be required. If, on the other hand, the voice command relates to a request for application server 220 to take certain actions (e.g., pay a bill to an associated third-party account), additional security information may be required.

As shown in FIG. 3, in some implementations, upon determining 321 that the received voice command relates to information that can be provided to computing device user 205, application server 220 can provide 323 the requested information to application 306 such that it can be presented to computing device user 205. For example, based on known commands and/or other voice recognition, if the received voice command relates to an account balance inquiry, application server 220 can access database 216 to retrieve the relevant account-related information. Further, processor 218 can generate an appropriate response such that application server 220 can output 323 the account balance information such that it can be output for display at computing device 210 via a display interface 104 associated with computing device 210. Alternatively, application server 220 can output 323 the account balance in an audio format such that it can be output via sound interface 116 (e.g., as a spoken response to the inquiry). Thus, in the foregoing example, if the voice command asked, “How much did I spend last evening,” application server 220 may output a response of, “You made three purchases totaling $124” to be output via sound interface 116. In some implementations, aspects of the disclosed technology may allow computing device user 205 to customize a voice for providing the outputted response. For example, computing device user 205 can select a celebrity voice to provide the response.

As further shown in FIG. 3, in some implementations, application server can determine 321 that that the received voice command relates to a requested transaction. For example, a requested transaction can be to transfer funds between accounts provided by the financial institution and held by mobile device user 205. For example, if mobile device user 205 has a checking account, savings account, and credit card account with the financial institution, a requested transaction could be to transfer money from the savings account to the checking account or to pay an outstanding balance on the credit card account using funds from the checking account. Further, in some implementations, a requested transaction could be to redeem rewards associated with the financial account held by mobile device user 205. Similarly, a requested transaction can be to a request to pay an outstanding bill to a third party. Thus, in some implementations and as shown in FIG. 3, application server 220 can initiate 325 the transaction with an appropriate third-party server (e.g., third-party server 225). Accordingly, in the foregoing example, if the received voice command was a request to pay a bill, application server 220 can initiate, as the payor, the payment to the third-party server (e.g., 225) associated with the designated payee, payee's bank, or a bill payment system. In other implementations, a requested transaction can be a request for a third party to pay an outstanding bill associated with the financial institution. In an example scenario, mobile device user 205 has a credit card account with the financial institution and a checking account with a third party (e.g., a third-party bank). Accordingly, a requested transaction could be for the third-party bank to pay an outstanding balance associated with the credit card account with the financial institution. In such implementations, and as shown in FIG. 3, application server 220 can initiate 325 such a transaction with the third-party bank (e.g., third-party server 225). In some implementations, third-party server 225 may be associated with an electronic network for payment transactions, such as the Automated Clearing House (ACH), managed by NACHA, or another electronic funds transfer or payments network.

In some implementations, initiating 325 a transaction with a third-party server (e.g., third-party server 225, which can be associated with a third-party bank, utility company, credit card provider, or other third party) can include authenticating computing device user (e.g., transmitting 319 a request for security information or via a pre-registration of computing device 210). Additionally, initiating 325 a transaction can include securely connecting to a server associated with the third party (e.g., third-party server 225) and validating third-party accounts associated with mobile device user 205. Further, initiating 325 a transaction can include authorizing the requested transaction. In some implementations, after the third party completes the requested transaction, application server 220 may receive a confirmation of the completed transaction from third-party server 225.

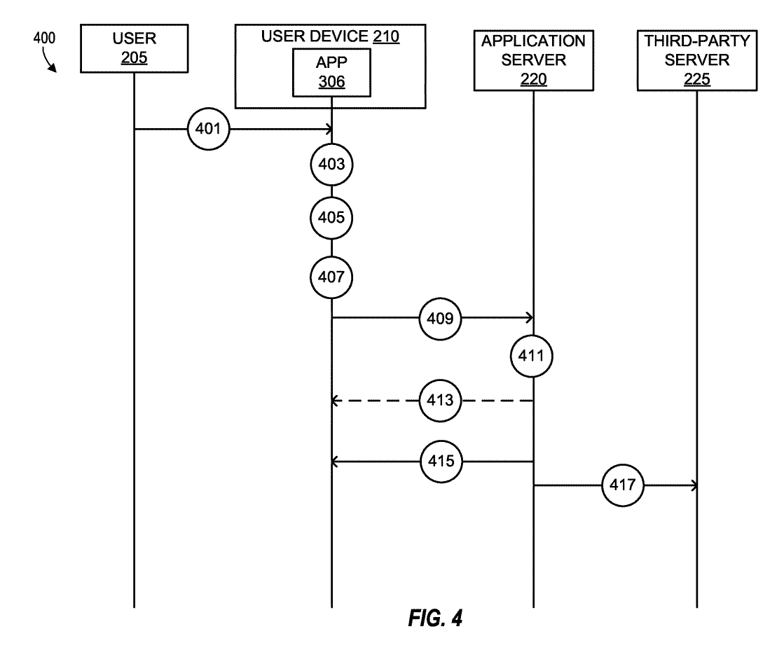

FIG. 4 is a sequence diagram illustrating an exemplary process 400, according to an example implementation. As will be understood, process 400 is similar to process 300 described above, though certain components have been excluded from the example. Thus, as shown in FIG. 4, in some implementations, it may not be necessary for user device 210 to include both VR APP 304 and application 306. Instead, application 306 may include the voice recognition technology previously provided by VR APP 304. Accordingly, as shown in FIG. 4, in some implementations, application 306 can receive 401 one or more voice commands and create 403 a digital audio file representing the voice command. Further, in some implementations, application 306 can process 405 the digital audio file to create a data file that represents the voice command. Further, in some implementations, application 306 can process 407 the data file (e.g., parse the data file) to determine the nature of the voice command. In other words, as will be appreciated, in some implementations, aspects of the processing illustrated in FIG. 3 as carried out by various components can be consolidated and carried out by a single component (e.g., application 306) executing on computing device 210.

As shown in FIG. 4, in some implementations, after determining the nature of the request, application 306 may transmit 409 an indication of the request to an associated application server 220. Thus, for example, if application 306 determines 407 that the voice command is related to a balance inquiry, application 306 can transmit 409 the balance inquiry request to application server 220. In some implementations, application server 220 may optionally determine 411 that the request requires further account validation and transmit 413 a request for such validation, as discussed in relation to FIG. 3. Further, application server 220 may transmit 415 the requested information to application 306 such that it can be output to computing device user 205 in a manner such as those previously discussed. Further, as shown in FIG. 4, if the request relates to, for example, initiating a payment to a third party, application server 220 may initiate 417 such payment in a manner similar to discussed in relation to FIG. 3.

In some implementations, a voice command from computing device user 205 may initiate a dialog between computing device user 205 and computing device 210, VR APP 304, and/or application 306. Thus, for example, computing device user 205 may provide a voice command relating to account rewards (e.g., “What is my rewards balance?”). Application server 220 may determine the rewards balance according to the disclosure provided, and computing device user 205 may provide a related follow-up voice command (e.g., “What can I spend my rewards points on?”). Again, application server 220 may determine an appropriate response to provide to computing device user 205. In response, computing device user 205 may provide an additional voice command to redeem certain rewards points on an identified item, and application server 220 may initiate the transaction as described above.

Though not shown in FIG. 3 or 4, in some implementations, the disclosed technology may determine the nature of the voice command without first converting from a digital audio file to a data file. Put differently, in certain implementations, an application (e.g., application 306) may receive a voice command, create a digital audio file representing the voice command, and determine the nature of the voice command directly from the digital audio file.

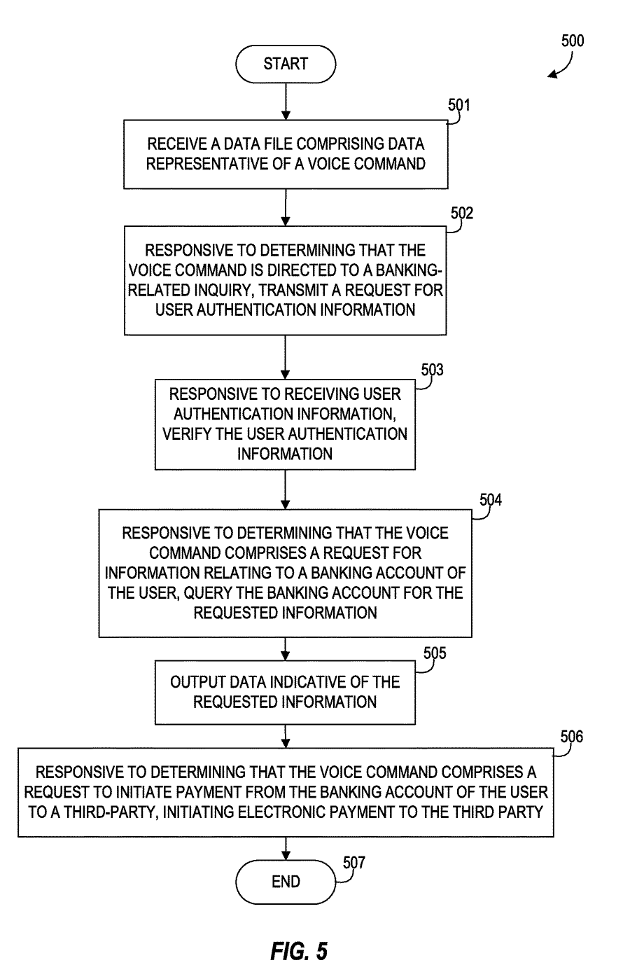

FIG. 5 is a flow diagram of a method 500, according to an example implementation. As shown in FIG. 5, in some implementations, the method includes, at 501, receiving a data file comprising data representative of a voice command. For example, as discussed above, computing device 210 can receive a voice command that can be converted into an audio file, and the audio file can be converted to a separate data file, which can be received by, for example, application server 220. At 502, the method can include determining that the voice command is directed to a banking-related inquiry. For example, application server 220 may determine the voice command is related to, or seeking access to, sensitive financial account information. Accordingly, application server 220 may transmit, to computing device 210, a request for user authentication information. In some embodiments, user authentication information may include computing device user 205 verbally providing, for example, a pass code or password. Additionally, user authentication information may include computing device user 205 manually inputting, for example, a swipe gesture at computing device 210. Upon receipt of the user authentication in formation, at 503, the method may include verifying the user authentication information. In some embodiments, application server 220 may compare the received user authentication information to stored user authentication information. In some implementations, at 504, the method may include determining that the voice command comprises a request for information relating to a bank account of computing device user 205, and querying the banking system that stores and manages the banking account for the requested information. Further, the method may include outputting, at 505, data representative of the requested information such that it can be provided to computing device user 205 via computing device 210 (e.g., verbally or via a display associated with computing device 210). Additionally, in some embodiments, the method may include, at 506, determining that the voice command comprises a request to initiate payment from the banking account of the user and initiating electronic payment to an appropriate third party. As discussed, in an example scenario, a user (e.g., mobile device user 205) may have a checking, savings, and credit account with a financial institution associated with application server 220. In addition, the user may a utility account associated with a third-party server or additional financial accounts associated with a third-party server. Thus, in various examples, a user can request an account-to-account transaction with the user's financial institution accounts (e.g., pay an outstanding credit balance with funds from the user's checking account). Additionally, the user may request to pay an outstanding balance to a third party (e.g., pay a utility account balance from funds in the user's financial institution checking account). Further, in some examples, a user can determine there is an outstanding balance associated with the user's credit account with the financial institution and request that the balance be paid from funds associated with a third-party financial institution account. Finally, the method may end at 507.

For convenience and ease of discussion, implementations of the disclosed technology are described above in connection with a financial or banking account associated with a user. But it is to be understood that the disclosed implementations are not limited to financial or banking accounts and are applicable to various other accounts associated with a user's sensitive information (e.g., utility/service accounts, medical information, and various other sensitive information).

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra mobile PCs (UMPCs), wearable devices, and smartphones. Additionally, implementations of the disclosed technology can be utilized with internet of things (IoT) devices, smart televisions and media devices, appliances, automobiles, toys, and voice command devices, as well as peripherals configured for use with such devices.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method comprising:
receiving, at a processor and from a computing device that executes an application associated with the processor, a data file, the data file comprising data representative of a voice command received at the computing device from a user;
responsive to determining, by the processor, that the voice command is directed to a banking-related inquiry, transmitting, to the computing device, a request for user authentication information;
responsive to receiving, at the processor, the user authentication information, verifying, by the processor, the user authentication information; and
responsive to determining, by the processor, that the voice command comprises a request for information relating to a banking account of the user, querying the banking account for the requested information and, outputting, by the processor and to the computing device, data indicative of the requested information.

2. The method of claim 1, wherein the data file comprises a text string.

3. The method of claim 2, wherein the text string comprises text of the voice command.

4. The method of claim 1, wherein the request for information relating to the banking account of the user comprises a request for a balance of the banking account of the user.

5. The method of claim 1, wherein the request for information relating to the banking account of the user comprises a request for purchases made during a particular time period.

6. The method of claim 1, the method further comprising:
responsive to determining, by the processor, that the voice command comprises a request to initiate payment from the banking account of the user to a third party, initiating electronic payment to the third party.

7. The method of claim 1, wherein the banking account of the user is a credit card account, the method further comprising:
responsive to determining, by the processor, that the voice command comprises a request to initiate payment from a third-party account of the user to the credit card account, initiating electronic payment from the third-party account to the credit card account.

8. The method of claim 1, wherein the banking account of the user is a first banking account, the method further comprising:
responsive to determining, by the processor, that the voice command comprises a request to initiate payment from the first banking account to a second banking account of the user, initiating electronic payment from the first banking account to the second banking account.

9. The method of claim 8, wherein the first banking account and the second banking account are associated with the same financial institution.

10. The method of claim 1, wherein the computing device is remote from the processor.

11. The method of claim 1, wherein the voice command is a natural-language voice command.

12. The method of claim 1, wherein the determining comprises parsing the data file.

13. The method of claim 1, wherein the computing device is executing an application associated with the processor.

14. A system comprising:
one or more processors;
a memory coupled to the one or more processors and storing instructions that, when executed by the one or more processors, cause the system to:
receive, from a computing device, a data file, the data file comprising data representative of a voice command received at the computing device from a user;
responsive to determining that the voice command is directed to a banking-related inquiry, transmit a request for user authentication information;
responsive to receiving the user authentication information, verify the user authentication information; and
responsive to determining that the voice command comprises a request for information relating to a banking account of the user, query the banking account for the requested information and, output, to the computing device, data indicative of the requested information.

15. The system of claim 14, wherein the data file comprises a text string comprising text of the voice command.

16. The system of claim 14, wherein the request for information relating to the banking account of the user comprises a request for a balance of the banking account of the user.

17. The system of claim 14, wherein the request for information relating to the banking account of the user comprises a request for purchases made during a particular time period.

18. The system of claim 14, wherein the banking account of the user is a first banking account, the system further storing instructions that, when executed by the one or more processors, cause the system to:
responsive to determining, by the processor, that the voice command comprises a request to initiate payment from the first banking account of the user to a third party, initiate electronic payment to the third party; and
responsive to determining, by the processor, that the voice command comprises a request to initiate payment from the first banking account of the user to a second banking account of the user, initiate electronic payment from the first banking account to the second banking account.

19. The system of claim 14, wherein the voice command is a natural-language voice command.

20. A non-transitory computer-readable medium storing instructions that, when executed by one or more processors, cause a first computing device to:
receive, from a second computing device executing an application associated with the first computing device, a data file, the data file comprising data representative of a voice command received at the computing device from a user;
responsive to determining that the voice command is directed to a banking-related inquiry, transmit a request for user authentication information;
responsive to receiving the user authentication information, verify the user authentication information; and
responsive to determining that the voice command comprises a request for information relating to a banking account of the user, query the banking account for the requested information and, output, to the second computing device, data indicative of the requested information.
